(19) United States
(12) Patent Application Publication
(10) Pub. No.: US 2017/0205942 A1
(43) Pub. Date: Jul. 20, 2017

(54) TOUCH TYPE INPUT APPARATUS

(71) Applicant: Boly Media Communications (Shenzhen) Co., Ltd., Shenzhen (CN)

(72) Inventor: Xiaoping HU, Shenzhen (CN)

(21) Appl. No.: 15/402,073

(22) Filed: Jan. 9, 2017

(30) Foreign Application Priority Data
Jan. 15, 2016 (CN) 201620042813.1

(51) Int. Cl. G06F 3/041; G06F 3/0481; G06F 3/0488; G06F 3/042

(52) U.S. Cl. CPC G06F 3/0416; G06F 3/042; G06F 3/04817; G06F 3/04886

(57) ABSTRACT

A touch type input apparatus may include a touch panel (110) and a substrate (120). The touch panel may be transparent. The substrate may be located beneath the touch panel and formed as a photoelectric conversion device. The substrate may be used to supply electricity to the input apparatus or external equipment. The touch panel may include at least one key area (111). The input signal generated by the touch operation of the user in each key area may be the key signal corresponding to the key area, and the icon (130) which is used to represent the key area may be arranged on the surface of the touch panel or the substrate. Because the photoelectric conversion device is used as the substrate of the transparent touch panel, on one hand, the occupancy of the input interface on the display interface is avoided; on the other hand, the input apparatus can be self-powered and even supply electricity to other equipments, and thereby the power source issue of the input apparatus is cleverly solved.

### TECHNICAL FIELD

The present disclosure relates to an input apparatus, in particular to a touch type input apparatus.

### BACKGROUND

With the widespread use of electronic products, the input apparatus is very common as the peripherals of the electronic products. Currently, the manual input is still a main input method. The input tools mainly include keyboard, mouse, touch screen and button, etc.

The common input apparatus using the touch screen is generally integrated with the display screen. The touch panel is covered on the display interface and the content inputted by the touch operation is displayed on the display interface. With this manner, the area of the display screen will be occupied during the inputting, and thereby the efficiency of information transmission will be reduced. Furthermore, since the input apparatus is integrated with the display screen, it is inconvenient to share between different equipments.

### SUMMARY

The present disclosure provides a touch type input apparatus which may include a touch panel and a substrate. The touch panel may be transparent and used to generate input signal in response to the touch operation of the user. The substrate may be located beneath the touch panel, formed as a photoelectric conversion device and able to convert the light energy irradiated onto its own surface into electrical energy. The substrate may be used to supply electricity to the input apparatus or external apparatus. The touch panel may include at least one key area, and the input signal generated by the touch operation of the user in each key area may be the key signal corresponding to the key area. The icon which is used to represent the key area may be arranged on the surface of the touch panel or the substrate.

The input apparatus of the present disclosure uses the photoelectric conversion device as the substrate of the transparent touch panel. On one hand, the occupancy of the input interface on the display interface is avoided and the share of the input apparatus between different equipments is facilitated; on the other hand, the input apparatus can be self-powered and even supply electricity to other equipments, and thereby the power source issue, especially in wireless connection, of the input apparatus is cleverly solved.

The specific examples of the present disclosure will be described in details below with reference to the drawings.

### BRIEF DESCRIPTION OF THE DRAWINGS

FIG. 1 schematically shows the configuration principle of the input apparatus according to the present disclosure;

FIG. 2 schematically shows the configuration of the input apparatus of embodiment 1;

FIG. 3 schematically shows the configuration of the input apparatus of embodiment 2;

FIG. 4 schematically shows the overall shape of the input apparatus of embodiment 3; and

FIG. 5 schematically shows another overall shape of the input apparatus according to the present disclosure.

### DETAILED DESCRIPTION

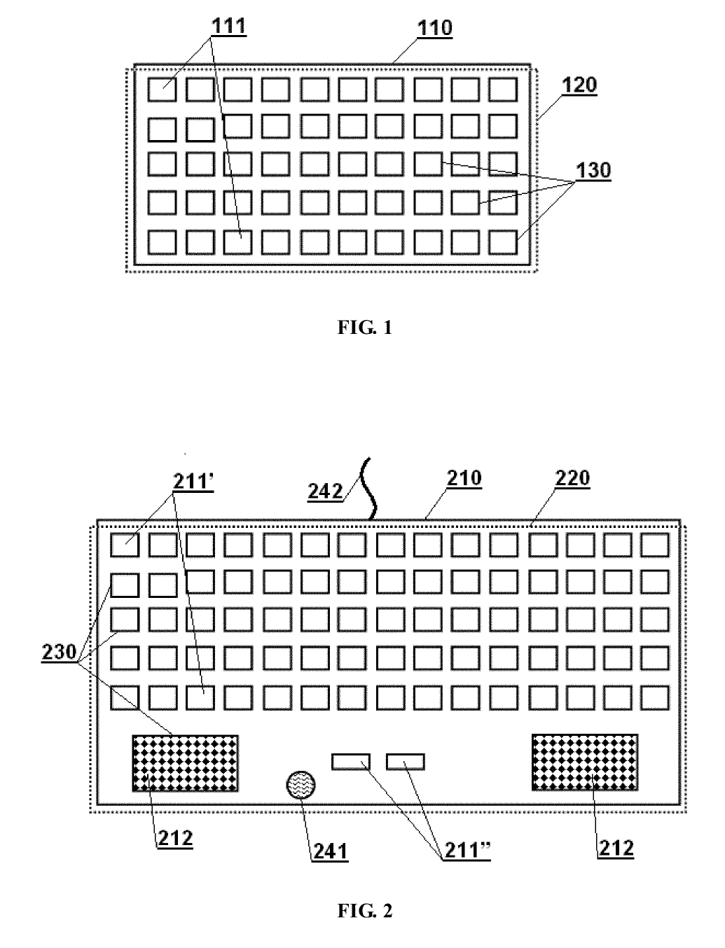

A configuration of an input apparatus according to the present disclosure is shown in FIG. 1, which may include a touch panel 110 and a substrate 120.

The touch panel 110 may be transparent and used to generate input signal in response to touch operation of a user. The input signal may be transmitted to electronic equipment connected with the input apparatus. The connection herein may include wired or wireless signal connection. The object used to perform the touch operation may be finger or stylus, etc.

The substrate 120 may be located beneath the touch panel and represented by dotted line in FIG. 1. The substrate may be formed as a photoelectric conversion device and able to convert the light energy irradiated onto its own surface into electrical energy. Since the input apparatus generally has large surface area, the substrate acting as light energy converter has the ability to provide enough electrical energy. The electrical energy generated by the substrate may be used to supply the input apparatus itself, or also supply external apparatus (such as cellular phone). The way for supplying electricity may include directly providing a power supply interface, or storing the electrical energy and providing it to external when needed, etc. The photoelectric conversion device used may be selected from photovoltaic panel and photovoltaic thin film, etc, such as silicon solar panel or thin film solar cell.

The touch panel 110 may include at least one key area 111. The input signal generated by the touch operation of the user in each key area may be the key signal corresponding to the key area.

The icon 130 which is used to represent the key area may be arranged on the surface of the touch panel or the substrate. For example, the icon 130 may be appeared on the upper or lower surface of the touch panel or on the surface of the substrate close to the touch panel by printing, etching or projection, etc. The icon 130 may include both the border representing the key area and the characters or symbols, etc representing the input signal, for ease of use.

The ways and processes by which the touch panel generates the input signal in response to the touch operation may be implemented with reference to the existing touch panel input methods, and will not be limited by the present disclosure. The corresponding manner between the key area and the key signal may be designed according to requirements of practical application. For example, each key area may represent a physical key, which is similar to the traditional keyboard; or one physical key may also a composite key of a plurality of virtual keys, which may be distinguished by preset input rules (for example, the combination of a plurality of keys) and will not be described in details.

By designing the size, arrangement and overall configuration of the key area of the input apparatus according to the present disclosure, a variety of input functions can be implemented. In an embodiment, there may be a plurality of key areas, the size of which may be equivalent to that of the key of an ordinary keyboard. At least a part of the key areas may be arranged according to set rules such that the input apparatus of the present disclosure may be formed as a keyboard by which the input is performed by touch. In another embodiment, the touch panel may further include at least one sliding area. The input signal generated by the touch operation of the user in the sliding area may be the movement signal corresponding to the movement generated by the touch operation, such that the input apparatus of the present disclosure can act as not only a keyboard, but also a mouse. Corresponding key areas may further be arranged to act as the left button and right button of the mouse.

Since the keys need not to be pressed, the input apparatus of the present disclosure may be formed integrally, and the substrate and the touch panel may be tightly combined together.

The input apparatus according to the present disclosure may be integrated with or separated from the electronic product or other external equipments (for example, the speaker or the microphone) of the electronic product. Therefore, the input apparatus may be provided with a variety of additional function devices based on the requirement of the practical application. For example, one or more of the following devices may be included:

an energy storage device which may be electrically connected with the substrate and used to store the electrical energy generated by the substrate and supply electricity to the input apparatus itself or other external equipments, where the energy storage device may be rechargeable battery or super capacitor, etc;

a communication device which may be used to communicate with the electronic equipment and transmit the input signal, etc., where the communication device may be wired or wireless communication device, such as infrared communication device, public radio frequency band communication device, Bluetooth device, WiFi device, WiMax device, 2G/3G/4G/5G communication device, etc., and it should be noted that the communication device for long-distance wireless communication (such as 3G/4G, etc.) may be not necessary in the application such as computer keyboard, but be preferred in remote distributed equipment such as handhold cash register terminal, terminals of mobile customer service platform, etc.;

an additional input device which may be used to collect the input information by other ways, such as image acquisition device for input of fingerprint or palm print, voice recognition device for input of sound signal, etc., where the input information of these devices may be alternately or cooperatively used with the input information of the touch panel;

a memory device which may be used to record the historical data inputted and generate input prompt for subsequent input based on the historical data, where the prompt may be displayed on other external equipment connected therewith, such as the screen; and

an interface device which may be used to connect a variety of external equipments and may include serial interface, parallel interface, USB interface, memory card (such as SD card, TFT card) interface, external speaker and microphone interface, network cable interface, etc.

The specific application forms of the input apparatus according to the present disclosure will be illustrated below.

### Embodiment 1

FIG. 2 schematically shows an embodiment of the input apparatus according to the present disclosure, which is a multi-functional touch type computer keyboard. The input apparatus may include a touch panel 210 and a substrate 220 (represented by the dotted line).

The touch panel 210 may include a plurality of key areas and two sliding area 212. Icons 230 which may be used to represent the areas may be arranged on the surface of the touch panel or the substrate. The key areas adopting touch input may be divided into two groups. The first group may include a plurality of key areas 211′ whose sizes and arrangement are equivalent to those of the keys of an ordinary keyboard. The second group may include two key areas 211″ which have size equivalent to ordinary keys and are arranged between two sliding areas to act as the left button and the right button of the mouse. The two sliding areas may be arranged at the left side and the right side of the input apparatus, respectively, such that it can be conveniently used by either left-handed or right-handed user. In other embodiments, there may be only one sliding area arranged at the left or right side of the input apparatus.

The present embodiment may further be provided with the following additional device: a control circuit (not shown) and a voice recognition device (not shown).

The control circuit may be used to switch the input apparatus between a working state and an idle state. In the working state, the touch panel may be able to generate the input signal. In the idle state, the touch panel may be in a power saving mode. For example, the touch panel may be shut down such that it will not respond the touch operation, or the touch panel may work in a low power mode such that it will not generate the input signal but be able to activate the input apparatus in response to the touch operation at any location to take the input apparatus into the working state. The switching between the working state and the idle state may be automatically performed by the control circuit. For example, when a time period during which the touch panel does not detect any touch operation exceeds a pre-set time, the input apparatus may be switched into the idle state, and when the touch panel detects touch operation at any location thereof, the input apparatus may be switched into the working state. The switching between the working state and the idle state may be performed by the control circuit based on the switching signal generated by a switch set by the user with touch. The two switching methods may be cooperatively used.

The voice recognition device (not shown) may be used to cooperate with a microphone 241 to implement the voice input. In the keyboard of the present embodiment, the voice input and the manual input may be cooperatively used, and one of a plurality of key signals corresponding to a single touch operation, or one of a plurality of current possible inputs, may be selected based on the sound signal inputted, thereby greatly increasing the convenience of the inputting. For example, the voice input (for example, the voice representing the orientation, such as up, down, left, right, etc.) may be used to select the capitalization of letters, or select one of a plurality of virtual keys represented by one physical key, or select one of a plurality of homophones presented, etc. This way, on one hand, the convenience of the voice input is utilized; on the other hand, since the voice itself is not the inputted content, the drawback of lack of privacy of current voice input may be avoided.

The keyboard of the present embodiment may be used to replace conventional keyboard and mouse, and may be cooperatively used with a variety of computers (for example, desktop computer, laptop or tablet computer, etc.) through a connecting cable 242 (for example, a USB cable). Since the keyboard of the present embodiment can be easily designed as an ultra-thin and enclosed monolithic apparatus, it can be separated from the computer and used with different computers. Therefore, not only it is easy to carry, but also the waste can be reduced.

The input apparatuses of the present and subsequent embodiments may further be provided with more additional function devices as described above, which will not be described in details herein.

### Embodiment 2

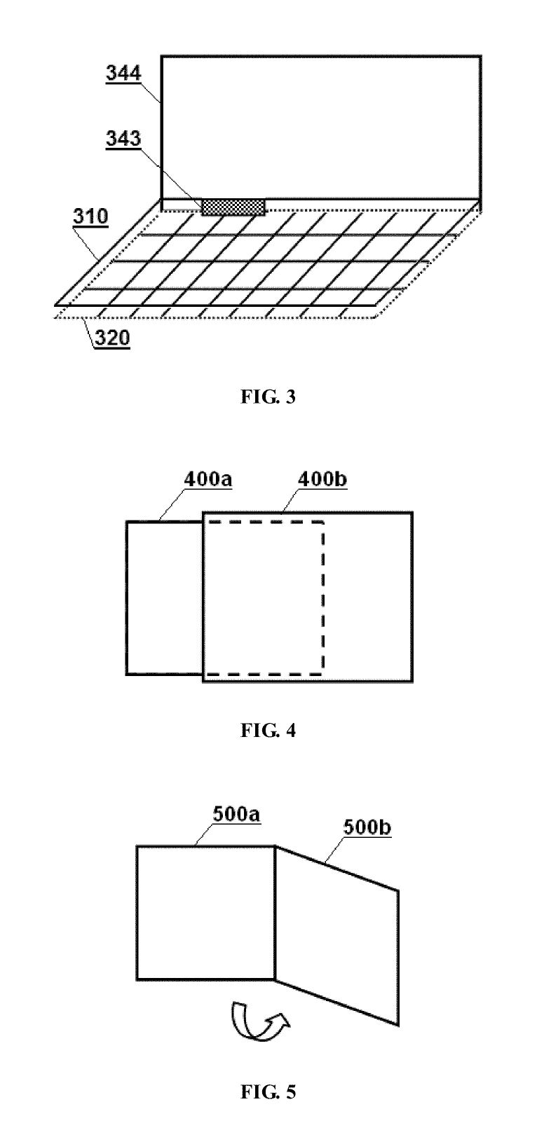

FIG. 3 schematically shows another embodiment of the input apparatus of the present disclosure, which is a multi-functional cell phone protective case. In the present embodiment, the input apparatus may include a touch panel 310 and a substrate 320 (represented by the dotted line), the specific configuration of which may be as shown in FIG. 1. The input apparatus may be formed as a waterproof configuration which is enclosed in its entirety, and be connected with the cell phone 344 through a connection port 343. The input apparatus may act as both the protective case of the screen of the cell phone and the input interface. Because the input apparatus no longer occupies the display screen, the size of the keys can be increased. Therefore, not only the displaying will not be affected, but also the input efficiency of the user can be increased.

In the present embodiment, the substrate 320 may be a double-sided photovoltaic panel such that the back of the input apparatus (the protective case) can also perform the photoelectric conversion. Thereby, when the protective case is covered on the cell phone, it can still recharge the cell phone by the light energy, and thereby the working time of the cell phone can be effectively increased.

### Embodiment 3

FIG. 4 schematically shows another embodiment of the input apparatus of the present disclosure, which is a retractable keyboard.

In the present embodiment, the specific configuration of the keyboard may be similar to the embodiments above. The keyboard may be wholly formed as two parts 400a and 400b which can slide with respect to each other such that, during storage, the overall size of the keyboard may be greatly reduced and it is more portable. Since the combination configuration of the touch panel with the substrate adopted by the input apparatus according to the present disclosure is very easy to be formed as a monolithic configuration, it is very easy to divide the entire keyboard into two or more parts. The separated parts can communicate with each other through wired or wireless (for example, infrared) communication, etc.

In other embodiment, the separated parts may also be connected with each other by pivoting. For example, as shown in FIG. 5, the two parts 500a and 500b forming the input apparatus may be folded together by rotation.

The principles and embodiments of the present disclosure have been described with reference to specific examples hereinbefore. However, it should be understood that the embodiments above are merely used to facilitate the understanding to the present disclosure, but should not be interpreted as limitations thereto. For a person ordinarily skilled in the art, modifications to the specific embodiment above may be made according to the concepts of the present disclosure.

1. A touch type input apparatus, comprising:
a touch panel which is transparent and used to generate an input signal in response to a touch operation of an user; and
a substrate which is located beneath the touch panel, wherein the substrate is formed as a photoelectric conversion device and is able to convert light energy irradiated onto its own surface into electrical energy, and the substrate is used to supply electricity to the input apparatus or an external equipment;
wherein the touch panel comprises at least one key area, and an input signal generated by a touch operation of the user in each key area is a key signal corresponding to the key area; and
an icon which is used to represent the key area is arranged on a surface of the touch panel or the substrate.

2. The apparatus of claim 1, wherein:
there are a plurality of key areas, and at least a part of the key areas are arranged according to set rules to form a keyboard.

3. The apparatus of claim 1, wherein:
the touch panel further comprises at least one sliding area, and an input signal generated by a touch operation of the user in the sliding area is a movement signal corresponding to movement generated by the touch operation.

4. The apparatus of claim 3, wherein:
there is one sliding area which is arranged at the left or right side of the input apparatus; or, there are two sliding areas which are arranged at the left side and the right side of the input apparatus, respectively.

5. The apparatus of claim 1, further comprising an energy storage device which is electrically connected with the substrate and used to store electrical energy generated by the substrate.

6. The apparatus of claim 5, wherein:
the energy storage device is rechargeable battery or super capacitor.

7. The apparatus of claim 1, further comprising a control circuit which is used to switch the input apparatus between a working state and an idle state, wherein in the working state, the touch panel is able to generate the input signal, and in the idle state, the touch pad is in a power saving mode.

8. The apparatus of claim 7, wherein:
the control circuit is further used to automatically perform the switching between the working state and the idle state, wherein when a time period during which the touch panel does not detect any touch operation exceeds a pre-set time, the input apparatus is switched into the idle state, and when the touch panel detects touch operation at any location thereof, the input apparatus is switched into the working state; or
the control circuit is further used to perform the switching between the working state and the idle state based on a switching signal generated by a switch set by the user with touch.

9. The apparatus of claim 1, further comprising a voice recognition device which is used to select one of a plurality of key signals corresponding to a single touch operation or select one of a plurality of current possible inputs based on sound signal inputted.

10. The apparatus of claim 1, wherein:
the input apparatus is wholly formed as at least two parts which are connected with each other by sliding or pivoting.
